(19) United States
(12) Patent Application Publication
(10) Pub. No.: US 2006/0088172 A1
(43) Pub. Date: Apr. 27, 2006

(54) Speaker apparatus for vehicle

(75) Inventors: Koji Takayama, Yamagata (JP); Shinichi Hayasaka, Yamagata (JP); Kazuki Yuze, Yamagata (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION and TOHOKU PIONEER

(21) Appl. No.: 11/258,517

(22) Filed: Oct. 26, 2005

(30) Foreign Application Priority Data
Oct. 27, 2004 (JP) 2004-312724

(51) Int. Cl. H04B 1/00

(52) U.S. Cl. 381/86; 381/398

(57) ABSTRACT

A speaker apparatus for vehicle in which a resin terminal plate is mounted on a speaker frame supporting a diaphragm of a speaker unit and at least one network element is mounted on the resin terminal plate. The network element on the resin terminal plate is covered with a resin hood, protecting the network element from water droplets due to dewing and preventing the network element from being contaminated.

### BACKGROUND OF THE INVENTION

1. Field of the Invention

The present invention relates to a speaker apparatus for vehicle in which a resin terminal plate is mounted on a speaker frame supporting a diaphragm of a speaker unit and the network elements are mounted on the resin terminal plate.

2. Description of the Related Art

To compose a multi-way loudspeaker system like an audio system for vehicle, various types of speaker apparatuses for vehicle have been developed in which the resin terminal plate is mounted on the speaker frame supporting the diaphragm of the speaker unit and the network elements are mounted on the resin terminal plate due to constraints on the mounting space of the vehicle.

FIG. 1 shows a resin terminal plate 1 mounted on a speaker frame and the network elements 3 and 4 mounted on the resin terminal plate 1 in the speaker apparatus for vehicle.

The resin terminal plate 1 is equipped with the input terminals 7a and 7b for connecting the output line from an external amplifier, in addition to the above elements 3 and 4. Conventionally, a structure of securing the resin terminal plate 1 on the speaker frame has been well known in which a female thread is worked in the speaker frame, and the resin terminal plate 1 is screwed on the speaker frame (e.g., refer to JP-A-2004-187233).

A large network element 3 on the resin terminal plate 1 is a choke coil, and a small network element 4 is a condenser or resistor, both being secured barely on the resin terminal plate 1 (e.g., refer to JP-A-2001-251694).

The small and light network element 4 is secured on the resin terminal plate 1 by soldering the lead wire to a terminal fitting fixed on the resin terminal plate 1. However, the large and heavy network element 3 can not have a sufficient fixation strength to withstand the vibrations of the vehicle only by soldering or bonding the lead wire. Conventionally, it is secured on the resin terminal plate 1, employing a binding band 9 made of resin, as shown in FIG. 1.

### SUMMARY OF THE INVENTION

However, in the structure in which the network elements 3 and 4 are secured barely on the resin terminal plate 1 as shown in FIG. 1, the rainwater entering inside the doors or water droplets due to dewing arising on the inner face of a vehicle panel to which the speaker apparatus is mounted may possibly contact these elements, contaminating the elements.

In the conventional terminal plate mounting structure for securing the resin terminal plate 1 on the speaker frame, the speaker frame press molded must be transferred to another process line for working the thread, resulting in a problem that the number of processes of manufacturing the speaker frame is increased and the unit price of components is higher.

The securing structure by screwing has the increased number of parts, making the assembling process complex.

Since the distal end of attached screw projects inward of the frame, it is required to keep an empty space so that a damper or a diaphragm mounted within the frame may not interfere with the distal end of screw, when in amplitude, preventing the miniaturization of the speaker apparatus.

In the mounting structure for the large choke coil employing the binding band 9 as shown in FIG. 1, it is required to excise an excess length after fastening the binding band 9, whereby it takes a lot of time for assembling, resulting in a problem that the productivity is bad.

It is an object of the invention to provide a speaker apparatus for vehicle in which the operation reliability and durability are improved by preventing contamination of the network elements, for example, due to water.

It is another object of the invention to provide a speaker apparatus for vehicle in which the assembling ability is improved, and the number of sub-assemblies is reduced, with the lower cost, by retrofitting the screw securing structure.

According to an aspect of the invention, there is provided with a speaker apparatus for vehicle, including: a speaker unit having a diaphragm; a speaker frame supporting the diaphragm; a resin terminal plate being attached to the speaker frame; a network element being mounted on the resin terminal plate; and a resin hood being attached to the resin terminal plate, and the resin hood covering the network element.

According to another aspect of the invention, there is provide with a speaker apparatus for vehicle, including: a speaker unit having a diaphragm; a speaker frame supporting the diaphragm, the speaker frame having an engagement hole formed on a mounting flange portion; a resin terminal plate being attached to the speaker frame, the resin terminal plate having an elastic engaging portion engageable with the engagement hole, the elastic engaging portion being integrally formed with the a resin plate; and a network element being mounted on the resin terminal plate. The resin terminal plate is fixed to the speaker frame when the elastic engaging portion of the resin terminal plate is engaged with the engagement hole of the mounting flange portion of the speaker frame.

According to another aspect of the invention, there is provided with a speaker apparatus for vehicle, including: a speaker unit having a diaphragm; a speaker frame supporting the diaphragm; a resin terminal plate being attached to the speaker frame, the resin terminal plate having an engagement hole; a network element being mounted on the resin terminal plate, the network element including a choke coil; and a resin case accommodating the choke coil, the resin case including an elastic engaging portion engageable with the engagement hole. The choke coil is fixed to the resin terminal plate when the elastic engaging portion of the resin case is engaged with the engagement hole of the resin terminal plate.

### BRIEF DESCRIPTION OF THE DRAWINGS

FIG. 1 is an explanatory view for a mounting structure for mounting a resin terminal plate on a speaker frame and the network elements on the resin terminal plate in the conventional speaker apparatus for vehicle.

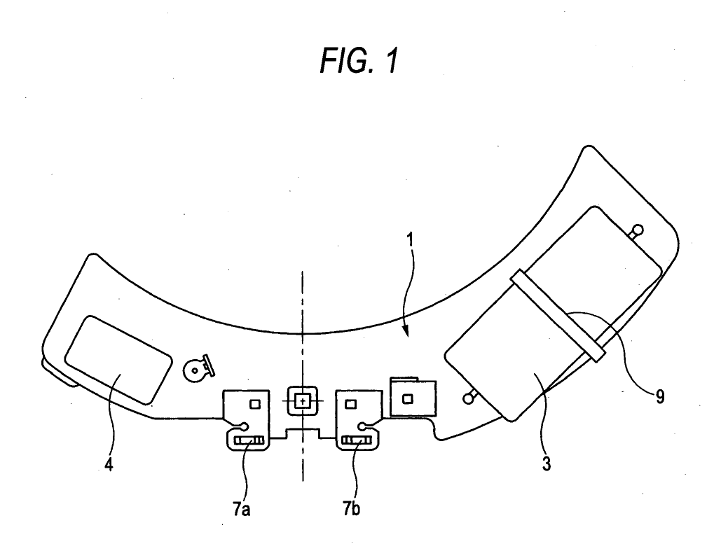

FIG. 2 is a longitudinal cross-sectional view of a speaker apparatus for vehicle according to an embodiment of the invention.

FIG. 3 is a perspective view of the resin terminal plate as shown in FIG. 2, as seen from the arrow III.

FIG. 4 is a plan view in a state where the resin cover is removed from the resin terminal plate as shown in FIG. 3.

FIG. 5 is a perspective view of FIG. 4, as seen from the arrow V.

### DESCRIPTION OF THE PREFERRED EMBODIMENTS

An embodiment of a speaker apparatus for vehicle will be described below in detail with reference to the drawings.

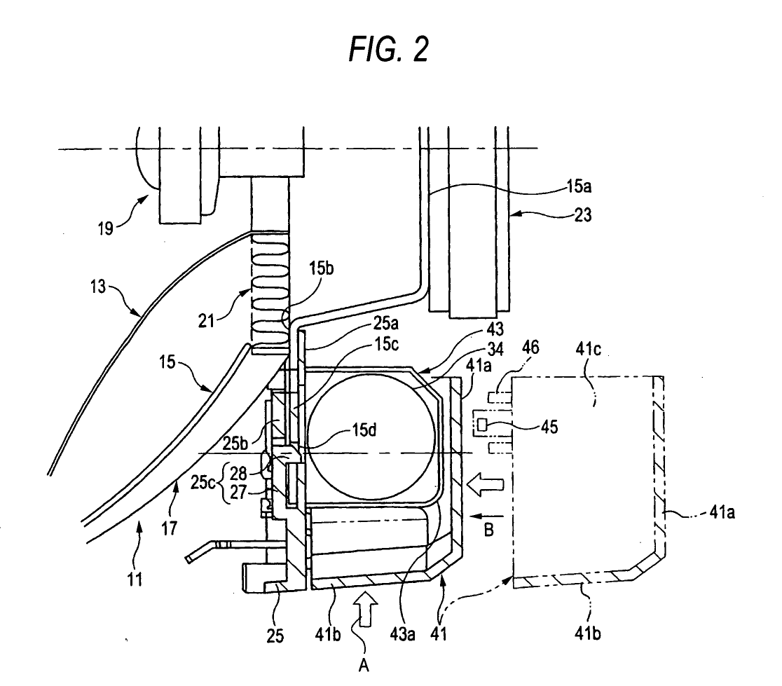

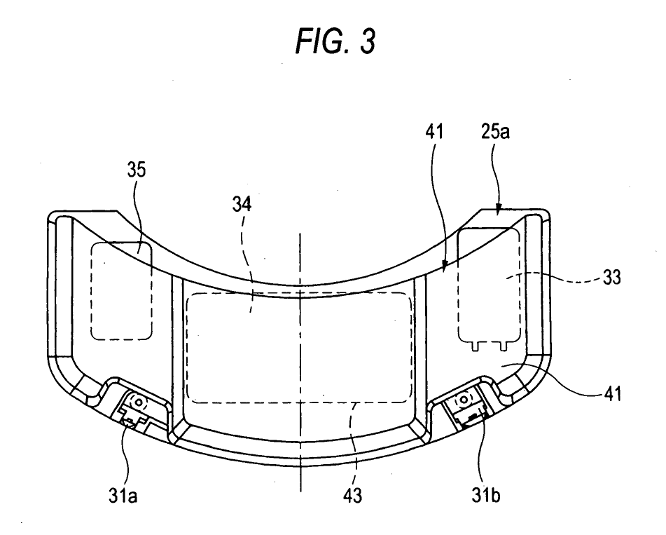

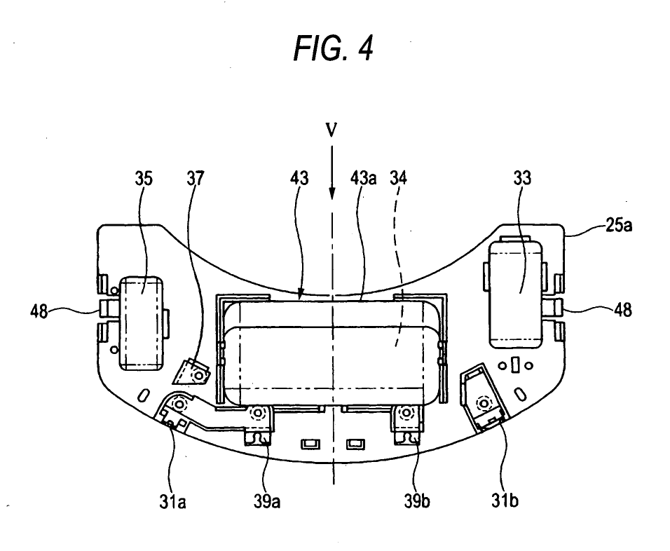

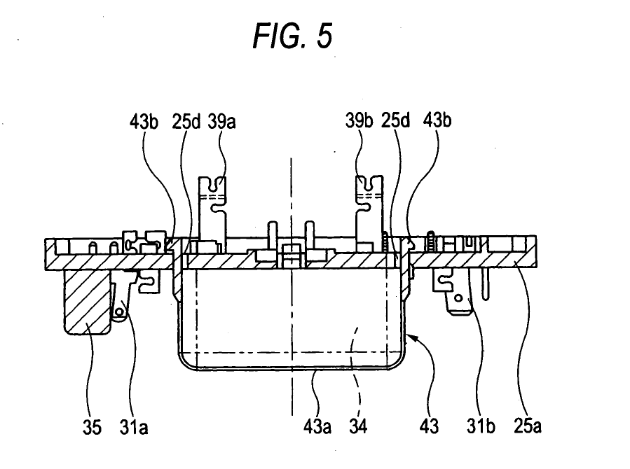

FIGS. 2 to 5 show a speaker apparatus for vehicle according to the embodiment. FIG. 2 is a longitudinal cross-sectional view of the speaker apparatus for vehicle according to the embodiment. FIG. 3 is a perspective view of a resin terminal plate as shown in FIG. 2, as seen from the arrow III. FIG. 4 is a plan view in a state where a resin cover is removed from the resin terminal plate as shown in FIG. 3. FIG. 5 is a perspective view of FIG. 4, as seen from the arrow V.

A speaker apparatus 11 for vehicle is a two-way speaker apparatus including a woofer unit 17 for low range in which a cone-type diaphragm 13 is supported on a speaker frame 15 and a tweeter unit 19 for middle and high range that is disposed on the central axis of the cone-type diaphragm 13.

The cone-type diaphragm 13 of the woofer unit 17 has an edge portion on the outer rim secured to an edge supporting portion like a ring in a speaker frame 15, though not shown. Also, the inner rim of the cone-type diaphragm 13 is borne via a corrugate damper 21 on the speaker frame 15, as shown in the drawings. A voice coil bobbin is joined on the inner rim of the cone-type diaphragm 13, and a voice coil wound around this voice coil bobbin is inserted into a magnetic gap formed by a magnetic circuit 23 fixed to the rear end of the speaker frame 15, though not shown.

The speaker frame 15 is a press molding of a metallic plate and formed with a flat portion 15b for mounting the corrugate damper 21 at a position forward from a rear plate 15a that is a mounting portion of the magnetic circuit 23, and integrally with a mounting flange portion 15c for mounting the resin terminal plate 25 to be continuous to this flat portion 15b.

The mounting flange portion 15c is a flat plate extending radially outward from the outer circumference of the flat portion 15b and formed by cutting and standing a plate material in an area forming an opening portion of the speaker frame 15.

An engagement hole 15d is formed through this mounting flange portion 15c.

The resin terminal plate 25 includes an element mounting plate portion 25a like a flat plate, of which the inner rim overlaps a rear face of the flat portion 15b, a gap forming frame portion 25b for forming a gap into which the mounting flange portion 15c is inserted with the element mounting plate portion 25a, and an elastic engaging piece 25c (an elastic engaging portion) for engaging an engagement hole 15d of the mounting flange portion 15c fitted into the gap formed by the gap forming frame portion 25b, which are integrally formed by resin molding, as shown in FIG. 2.

This elastic engaging piece 25c has a structure in which an engaging projection 28 fitted into the engagement hole 15d projects at a distal end of an arm 27 extending along the mounting flange portion 15c.

The resin terminal plate 25 is secured to the speaker frame 15 by pushing it in a direction of the arrow A of FIG. 2 from radially outward of the mounting flange portion 15c to fit the mounting flange portion 15c into the gap formed by the gap forming frame portion 25b, and further pushing it in the direction of the arrow A to enable the engaging projection 28 of the elastic engaging piece 25c to engage the engagement hole 15d.

The element mounting plate portion 25a of the resin terminal plate 25 has mounted the input terminals 31a and 31b for connecting the output line from an external amplifier, the network elements 33, 34 and 35 for generating a signal corresponding to a reproduction frequency band for each unit 17, 19 from the signal inputted into the input terminals 31a and 31b, a terminal fitting 37 for making the electrical connection between the network elements 33, 34 and 35, the unit connection terminals 39a and 39b for connecting a network circuit having the network elements 33, 34 and 35 and the terminal fitting 37 to each unit 17, 19, and a resin hood 41 covering the network elements 33, 34 and 35 on the element mounting plate portion 25a, as shown in FIGS. 3 to 5.

In the embodiment, among the network elements 33, 34 and 35 mounted on the resin terminal plate 25, a small network element 33 is a condenser element, a small network element 35 is a resistor element and a large network element 34 is a choke coil.

In the embodiment, the choke coil that is the large network element 34 is accommodated within the resin case 43, as shown in FIGS. 2 and 5. This resin case 43 includes a case main body 43a for accommodating the network element 34 inside in the shape of a box with a bottom portion alone opened, and an elastic engaging piece 43b (an elastic engaging portion) for engaging the engagement hole 25d formed in the element mounting plate portion 25a of the resin terminal plate 25, extending from a lower end of the case main body 43a. The resin case 43 is secured to the resin terminal plate 25 by allowing the elastic engaging piece 43b to engage the engagement hole 25d.

The network element 34 within the resin case 43 is firmly bonded to the resin case 43 by epoxy resin filled within the case. As described above, the resin case 43 is secured to the resin terminal plate 25 so that the network element 34 is secured to the resin terminal plate 25.

The resin hood 41 covering the network elements 33, 34 and 35 on the element mounting plate portion 25a is made of transparent acrylic resin, and includes an upper wall portion 41a covering the upper part of each network element 33, 34 and 35, a front wall portion 41b suspended from the front edge of the upper wall portion 41a near the front edge of the resin terminal plate 25 and covering the front part of the network elements 33, 34 and 35 accommodated therein, and both side wall portions 41c and 41d suspended near both side edges of the resin terminal plate 25 and covering the side part of the network elements 33, 34 and 35 accommodated therein, as shown in FIGS. 2 and 3. Thereby, the resin hood 41 covers substantially the entire area of the upper surface of the resin terminal plate 25, except for the mounting portions of the input terminals 31a and 31b.

Both the side wall portions 41c and 41d of the resin hood 41 are integrally formed with an elastic engaging piece 46 having an engagement hole 45, as indicated by the two-dot chain line in FIG. 2.

If the resin hood 41 is pressed against the resin terminal plate 25 to be put over the resin terminal plate 25, as indicated by the arrow B of FIG. 2, an engaging projection 48 to be fitted into the engagement hole 45 that projects on either side portion of the resin terminal plate 25 corresponding to the elastic engaging piece 46 is fitted into the engagement hole 45, so that the resin hood 41 is secured to the resin terminal plate 25, as shown in FIG. 4.

As detailed above, in the speaker apparatus 11 for vehicle, the resin terminal plate 25 is secured to the speaker frame 15 by enabling the elastic engaging piece 25c formed integrally with the resin terminal plate 25 to engage the engagement hole 15d on the speaker frame 15, without using the screw, as shown in FIG. 2. Thereby, the assembling ability and productivity can be improved by reducing the number of screwed portions. In the above-embodiment, a plurality of engaging holes 15d and the elastic engaging pieces 25c may be provided.

The engagement hole 15d on the speaker frame 15 required to secure the resin terminal plate 25 can be worked through the same press molding process as when the speaker frame 15 is formed by press molding, in which another process line is not required, unlike the screw working. The process time is shortened, and the manufacturing cost of the speaker frame 15 is reduced by simplifying the manufacturing process for the speaker frame 15. Because the number of screw parts is reduced and the number of sub-assemblies is reduced, the manufacturing cost of the speaker apparatus 11 for vehicle can be reduced.

Since no screw protrudes inside the speaker frame 15 to secure the resin terminal plate 25, it is unnecessary to keep an excess space for avoiding interference between the damper 21 or diaphragm 13 and the screw inside the speaker frame 15, so that the speaker apparatus can be made thinner and smaller.

In the speaker apparatus 11 for vehicle, since the choke coil that is the large network element 34 is accommodated within the resin case 43 and mounted on the resin terminal plate 25, but not barely mounted, the choke coil is not soaked, for example, even if the rainwater entering inside the doors or the water droplets due to dewing arising on the inner face of a vehicle panel to which the speaker apparatus is mounted may drop to the resin terminal plate 25.

Accordingly, the operation reliability and durability are improved by preventing contamination of the choke coil due to water.

Since the resin case 43 for protection from the water is formed integrally with the elastic engaging piece 43b for fixing on the resin terminal plate 25, any other parts such as the binding band are unnecessary, whereby the number of sub-assemblies and the number of assembling steps are reduced to improve the productivity.

In the speaker apparatus 11 for vehicle, all the network elements 33, 34 and 35 mounted on the resin terminal plate 25 are covered with the resin hood 41, but not barely. Even if the water droplets due to dewing arising on the inner face of a vehicle panel to which the speaker apparatus is mounted may drop to the resin terminal plate 25, the network elements 33, 34 and 35 are not wetted easily because of the intervention of the resin hood 41.

Accordingly, the operation reliability and durability are improved by preventing contamination of the network elements 33, 34 and 35 due to water.

What is claimed is:

1. A speaker apparatus for vehicle, comprising:
a speaker unit having a diaphragm;
a speaker frame supporting the diaphragm;
a resin terminal plate being attached to the speaker frame;
a network element being mounted on the resin terminal plate; and
a resin hood being attached to the resin terminal plate, and the resin hood covering the network element.

2. A speaker apparatus for vehicle, comprising:
a speaker unit having a diaphragm;
a speaker frame supporting the diaphragm, the speaker frame having an engagement hole formed on a mounting flange portion;
a resin terminal plate being attached to the speaker frame, the resin terminal plate having an elastic engaging portion engageable with the engagement hole, the elastic engaging portion being integrally formed with the a resin plate; and
a network element being mounted on the resin terminal plate, wherein the resin terminal plate is fixed to the speaker frame when the elastic engaging portion of the resin terminal plate is engaged with the engagement hole of the mounting flange portion of the speaker frame.

3. A speaker apparatus for vehicle, comprising:
a speaker unit having a diaphragm;
a speaker frame supporting the diaphragm;
a resin terminal plate being attached to the speaker frame, the resin terminal plate having an engagement hole;
a network element being mounted on the resin terminal plate, the network element including a choke coil; and
a resin case accommodating the choke coil, the resin case including an elastic engaging portion engageable with the engagement hole, wherein the choke coil is fixed to the resin terminal plate when the elastic engaging portion of the resin case is engaged with the engagement hole of the resin terminal plate.
